(19) United States
(12) Patent Application Publication
(10) Pub. No.: US 2018/0105654 A1
(43) Pub. Date: Apr. 19, 2018

(54) METHOD FOR PRODUCING TIRE MEMBER

(71) Applicant: TOYO TIRE & RUBBER CO., LTD., Itami-Shi (JP)

(72) Inventor: Shuhei Koyama, Itami-shi (JP)

(73) Assignee: TOYO TIRE & RUBBER CO., LTD., Itami-Shi (JP)

(21) Appl. No.: 15/670,230

(22) Filed: Aug. 7, 2017

(30) Foreign Application Priority Data
Oct. 14, 2016 (JP) 2016-202821

(51) Int. Cl. C08J 3/24; C08K 5/16

(52) U.S. Cl. CPC C08J 3/242; C08K 5/16

(57) ABSTRACT

A method for producing a tire member yielded using at least a filler, a dispersing solvent and a rubber latex solution as raw materials comprises at least a step (iii) of dehydrating the rubber solidified product containing the filler to produce the tire member. The step (iii) is a step of adding, to the rubber solidified product containing the filler, a peptizer and a compound represented by the following formula (I):

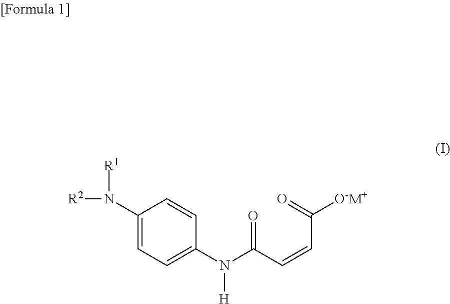

and dispersing the compound represented by the formula (I) in the rubber solidified product containing the filler, this product containing water, while dehydrating the rubber solidified product containing the filler.

### BACKGROUND OF THE INVENTION

### Field of the Invention

The present invention relates to a method for producing a tire member yielded using at least a filler, a dispersing solvent and a rubber latex solution as raw materials.

### Description of the Related Art

In the rubber industry, it has been hitherto known that at the time of producing a tire member including a filler such as carbon black, a wet rubber masterbatch is used to improve the tire member in workability and filler-dispersing performance. This masterbatch-used process is a process of mixing a filler and a dispersing solvent beforehand with each other at a predetermined ratio, and dispersing the filler into the dispersing solvent by mechanical force to prepare a filler-containing slurry solution; mixing the slurry solution with a rubber latex solution in a liquid phase; adding thereto a solidifier such as an acid to yield a solidified product; and then collecting and drying the solidified product. The use of the wet rubber masterbatch can give a tire member better in filler-dispersing performance and rubber physical properties such as workability and reinforceability than the use of a dry rubber masterbatch yielded by mixing a filler with a rubber in a solid phase. The use of such a tire member as a raw material makes it possible to produce, for example, a pneumatic tire decreased in rolling resistance and excellent in fatigue resistance, or such a rubber product.

The produced tire member may be used immediately after produced, or may be used after stored for a certain period. In order to prevent the tire member from being deteriorated during the storage, an antiaging agent is generally blended into the tire member, as described in Patent Document 1 listed below. However, when a large amount of the antiaging agent is blended into the tire member, the resultant vulcanized rubber tends to be deteriorated in rubber physical properties. Thus, it is required to make the blend amount of the antiaging agent as low as possible. In the step of dehydrating and drying a rubber solidified product, heat is applied to the rubber solidified product. However, the heat may cause an excessive advance of the cleavage of molecules of the rubber so that the finally obtained vulcanized rubber may be deteriorated in low exothermic property and breaking strength.

### PRIOR ART DOCUMENT

### Patent Document

Patent Document 1: JP-A-2014-95014

### SUMMARY OF THE INVENTION

In the light of the above-mentioned actual situation, the present invention has been made. An object thereof is to provide a method for producing a tire member that can restrain a vulcanized rubber obtained from this tire member frombeing lowered in rubber physical properties.

The object can be attained by the present invention described in the following: a method for producing a tire member yielded using at least a filler, a dispersing solvent and a rubber latex solution as raw materials, the method including: a step (i) of mixing the filler, the dispersing solvent and the rubber latex solution with each other to produce a rubber latex solution containing the filler; a step (ii) of solidifying the rubber latex solution containing the filler to produce a rubber solidified product containing the filler; and a step (iii) of dehydrating the rubber solidified product containing the filler to produce the tire member; wherein the step (iii) is a step of adding, to the rubber solidified product containing the filler, a peptizer and a compound represented by the following formula (I):

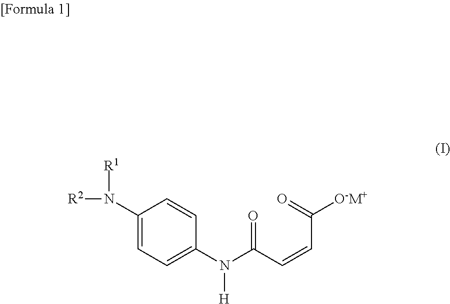

wherein R¹ and R² may be the same as or different from each other, and each represent a hydrogen atom, or an alkyl group, alkenyl group or alkynyl group that has 1 to 20 carbon atoms, and M⁺ represents a sodium ion, potassium ion or lithium ion; and dispersing the compound represented by the formula (I) in the rubber solidified product containing the filler, the product containing water, while dehydrating the rubber solidified product containing the filler.

According to this producing method, in the step (iii), the compound represented by the formula (I), i.e., the compound (I) is dispersed in the water-containing rubber solidified product containing the filler while the rubber solidified product containing the filler is dehydrated. Generally, a rubber used for tires shows hydrophobicity in a dry state. In the meantime, the compound (I) shows hydrophilicity; thus, even when a dry-state rubber is dry-mixed with the compound (I), the compound (I) is not improved in dispersibility in the rubber. However, according to the above-mentioned producing method, in the step (iii) corresponding to a dehydrating step, the compound (I) is dispersed into the water-containing rubber solidified product containing the filler so that the dispersibility of the compound (I) in this solidified product is dramatically heightened by aid of water. As a result, the compound (I) is dispersed at a high level in the rubber solidified product containing the filler. Once the compound (I) is dispersed in the rubber solidified product, the dispersibility of the compound (I) is kept even when the product is dehydrated, so that also in the finally obtained tire member, which is obtained by drying the product, the dispersibility of the compound (I) is improved. The compound (I) is excellent in antiaging effect, so that even when the produced tire member is stored for a long term, physical properties of the finally obtained vulcanized rubber can be kept. In short, the present producing method makes it possible to produce a tire member that can restrain a vulcanized rubber obtained from this tire member from being lowered in physical properties even when the tire member is stored for a long term.

Furthermore, according to the producing method, in the step (iii), the peptizer is added together with the compound (I) to the water-containing rubber solidified product containing the filler. This manner further produces the following advantageous effects (a) and (b):
(a) In the step (iii) corresponding to a dehydrating step, the blend of the peptizer makes it easy that rubber lumps loosen in the rubber solidified product. Thus, when the rubber solidified product is dehydrated in, e.g., a dehydrator, the rubber porosity in the rubber solidified product is lowered in the dehydrator. As a result, the efficiency of dehydrating the rubber solidified product is heightened so that this product can be efficiently lowered in water content. Thus, the method is improved in producing performance.
(b) In the step (iii), the presence of the peptizer promotes the generation of radicals in rubber molecules in the rubber solidified product to heighten the reactivity of the rubber molecule with the compound (I). Consequently, when the rubber solidified product is dehydrated in, e.g., a dehydrator, a thermal deterioration of the rubber can be restrained by the effect of the compound (I). Thus, the finally obtained vulcanized rubber can be improved in low exothermic property, and can be prevented from being deteriorated in breaking strength.

In the method for producing a tire member, it is preferred in the step (iii) that in the case of representing the water amount in the rubber solidified product containing the filler at the time of the addition of the compound (I) by Wa, and representing the addition amount of the compound represented by the formula (I) by Wb, the following expression is satisfied: 1≤Wa/Wb≤8100. As described above, in the presence of water, the compound (I) is remarkably improved in dispersibility in the rubber solidified product containing the filler by aid of water. In particular, when the expression “1≤Wa/Wb≤8100” is satisfied, the following two can be attained with a good balance: the dispersibility of the compound (I); and the shortening of a period necessary for removing water in the rubber solidified product containing the filler.

Furthermore, the present invention relates to a method for producing a tire member yielded using at least a filler and a rubber as raw materials, the method including: adding, to a mixture of the filler and the rubber, a peptizer, water, and a compound represented by the following formula (I) to disperse the compound into the mixture:

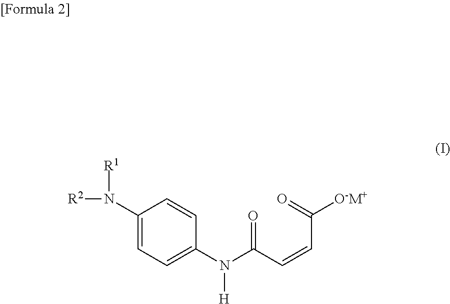

wherein R¹ and R² may be the same as or different from each other, and each represent a hydrogen atom, or an alkyl group, alkenyl group or alkynyl group that has 1 to 20 carbon atoms, and M⁺ represents a sodium ion, potassium ion or lithium ion.

In this producing method, in the presence of water, the compound (I) is dispersed in the mixture of the filler and the rubber. Generally, a rubber used for tires shows hydrophobicity in a dry state. In the meantime, the compound (I) shows hydrophilicity; thus, even when a dry-state rubber is dry-mixed with the compound (I), the compound (I) is not improved in dispersibility in the rubber. However, according to the above-mentioned producing method, in the presence of water, the compound (I) is dispersed into the mixture of the filler and the rubber, so that the dispersibility of the compound (I) in the mixture is dramatically heightened by aid of water. As a result, the compound (I) is dispersed at a high level in the mixture of the filler and the rubber. The compound (I) is excellent in antiaging effect, so that even when the produced tire member is stored for a long term, physical properties of the finally obtained vulcanized rubber can be kept. In short, the present producing method makes it possible to produce a tire member that can restrain a vulcanized rubber obtained from this tire member from being lowered in physical properties even when the tire member is stored for a long term.

Furthermore, in the producing method, in the presence of water, the peptizer is dispersed, together with the compound (I), into the mixture of the filler and the rubber. This manner makes it possible to improve the finally obtained vulcanized rubber in low exothermic property and prevent the rubber from being deteriorated in breaking strength.

In the method for producing a tire member, it is preferred that in the case of representing the addition amount of the water by Wa and representing the addition amount of the compound represented by the formula (I) by Wb, the following expression is satisfied: 1≤Wa/Wb≤8100. As described above, in the presence of water, the compound (I) is remarkably improved in dispersibility in the mixture of the filler and the rubber by aid of water. In particular, when the expression “1≤Wa/Wb≤7500” is satisfied, the following two can be attained with a good balance: the dispersibility of the compound (I); and the shortening of a period necessary for removing water in the mixture of the filler and the rubber.

### DETAILED DESCRIPTION OF THE PREFERRED EMBODIMENTS

In the method according to the present invention for producing a tire member, at least a filler, a dispersing solvent and a rubber latex solution are used as raw materials.

In the present invention, the filler denotes an inorganic filler used ordinarily in the rubber industry, such as carbon black, silica, clay, talc, calcium carbonate, magnesium carbonate, or aluminum oxide. In the invention, the use of carbon black, out of these inorganic fillers, is preferred.

The species of carbon black may be any carbon black species used in an ordinary rubbery industry, such as SAF, ISAF, HAF, FEF or GPF, or may be an electroconductive carbon black species such as acetylene black or ketjen black. The form of the carbon black species may be a granulated carbon black species, which has been granulated, considering the handleability thereof in an ordinary rubbery industry; or may be a non-granulated carbon black species.

The dispersing solvent is in particular preferably water, and may be, for example, water containing an organic solvent.

The rubber latex solution may be a natural rubber latex solution or a synthetic rubber latex solution.

The natural rubber latex solution is a natural product obtained by metabolic effect of a plant. Particularly preferred is a natural-rubber/aqueous latex solution in which a dispersing solvent is water. The number-average molecular weight of the natural rubber in the natural rubber latex solution used in the present invention is preferably 2,000,000 or more, more preferably 2,500,000 or more. About the natural rubber latex solution, concentrated latex, fresh latex named field latex, and other latexes are usable without being distinguished from each other. The synthetic rubber latex solution is, for example, a latex solution of styrene-butadiene rubber, butadiene rubber, nitrile rubber or chloroprene rubber produced by emulsion polymerization.

In the present invention, at the time of dehydrating the rubber solidified product containing the filler, which is yielded using at least the filler, the dispersing solvent, and the rubber latex solution as raw materials, a compound represented by the following formula (I) is added to the product:

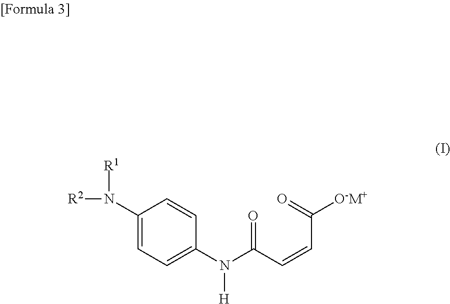

wherein R¹ and R² may be the same as or different from each other, and each represent a hydrogen atom, or an alkyl group, alkenyl group or alkynyl group that has 1 to 20 carbon atoms, and M⁺ represents a sodium ion, potassium ion or lithium ion.

In order to heighten the compound in affinity with the filler, particularly, carbon black, it is especially preferred to use a compound represented by the following formula (I′), in which R¹ and R² in the formula (I) are hydrogen atoms, and M⁺ is a sodium ion therein:

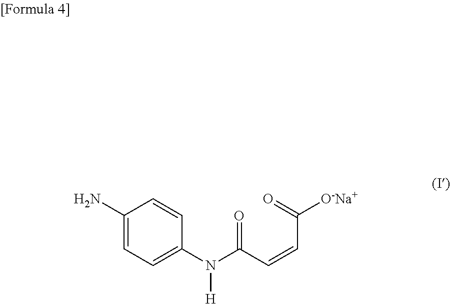

When the entire amount of the rubber component contained in the tire member is regarded as 100 parts by mass, the blend amount of the compound (I) is preferably from 0.1 to 10 parts by mass, more preferably from 0.5 to 8 parts by mass in the case of considering properties of the resultant vulcanized rubber.

When the rubber solidified product containing the filler is dehydrated in the present invention, a peptizer is added to the product together with the compound (I). The peptizer is also called a mastication promoter. When the rubber component is masticated in the state that the peptizer is blended into the rubber component, the peptizer generates radicals to generate polymer radicals in the rubber component to cause a cleavage reaction of polymeric main chains in the rubber component effectively. The peptizer is a blending agent used for this effect. In the present invention, examples of the peptizer include disulfides and mercaptans, such as o,o-dibenzamide diphenyl disulfide, a zinc salt of 2-benzamide thiophenol, 2-thionaphthol, thioxylenol, and pentachlorothiophenol. The peptizer may be anymixture obtained by adding a metallic catalyst into anyone of these compounds. The peptizer may be a thiazole such as 2-mercaptobenzothiazole; a diacyl peroxide such as benzoyl peroxide; a dialkyl peroxide such as dicumyl peroxide; or any other organic peroxide. Other examples of the peptizer include xylenethiol, pentachlorothiophenol, a zinc salt of pentachlorothiophenol, 4-tert-butyl-o-thiocresol, a zinc salt of 4-tert-butyl-o-thiocresol, mixed dixylyl/disulfide, zinc thiobenzoate, dibenzamide thiophenyl disulfide, a mixture of dibenzamide thiophenyl disulfide and stearic acid, alkylated phenol/sulfide, aromatic sulfur compounds, organic complex compounds, dinitroso/resorcinol, and high-molecular-weight oil-soluble sulfonic acids. Additional examples thereof include a piperidine salt of pentamethylenedithiocarbamic acid, and a mixture of dibenzamide diphenyl disulfide and stearic acid. The peptizer may be a cyclohexylamine salt of 2-mercaptobenzothiazole, N-cyclohexyl-2-benzothiazolylsulfenamide, or N-phenyl-N′-isopropyl-p-phenylenediamine, which is known as a vulcanization promoter. An especial peptizer may be used, examples thereof including compounds each obtained by incorporating a reactive functional group, such as a hydroxyl or carboxyl group, into the molecule of any one of the above-mentioned peptizers (hereinafter the compounds will each be referred to as the “functional-group-introduced peptizer”). These functional-group-introduced peptizers may be used singly or may each be used in combination with any one of the above-mentioned ordinary peptizers at any blend ratio. By using such a functional-group-introduced peptizer to masticate a natural rubber, the reactive functional group can be introduced into molecular chains of the natural rubber. Examples of a peptizer having a hydroxyl group, out of the functional-group-introduced peptizers, include 2-hydroxydiphenyl disulfide, 2-hydroxyethyl disulfide, mercaptophenol, 2-mercaptoethanol, and 3-mercapto-1,2-propanediol. Examples of a peptizer having a carboxyl group include mercaptobenzoic acid, mercaptoacetic acid, and mercaptopropionic acid. A carboxylic anhydride such as maleic anhydride is also usable as the functional-group-introduced peptizer. When, e.g., maleic anhydride is used in combination with any one of the above-mentioned peptizers at any blend ratio, anhydride groups can be incorporated into molecular chains of a natural rubber.

When the entire amount of the rubber component in the finally obtained rubber member is regarded as 100 parts by mass, the use amount of the peptizer is preferably from 0.01 to 1 part by mass, more preferably from 0.05 to 0.6 part by mass in order to enhance the target advantageous effect.

The following will specifically describe a method according to the present invention for producing a tire member. This producing method is a method for producing a tire member yielded using at least a filler, a dispersing solvent and a rubber latex solution as raw materials, the method including: a step (i) of mixing the filler, the dispersing solvent and the rubber latex solution with each other to produce a rubber latex solution containing the filler; a step (ii) of solidifying the rubber latex solution containing the filler to produce a rubber solidified product containing the filler; and a step (iii) of dehydrating the rubber solidified product containing the filler to produce the tire member; in which the step (iii) is a step of adding, to the rubber solidified product containing the filler, a peptizer and a compound represented by the formula (I), and dispersing the compound represented by the formula (I) in the rubber solidified product containing the filler, this product containing water, while dehydrating the rubber solidified product containing the filler.

### (1) Step (i)

The step (i) is a step of mixing a filler, a dispersing solvent and a rubber latex solution with each other to produce a rubber latex solution containing the filler. In the present invention, it is especially preferred that the step (i) includes a step (i-(a)) of dispersing the filler into the dispersing solvent, and adding, at the time of the dispersing, at least one portion of the rubber latex solution to the dispersing solvent to produce a slurry solution containing the filler to which particles of the rubber latex adhere, and a step (i-(b)) of mixing the slurry solution containing the filler, to which the rubber latex particles adhere, with the rest of the rubber latex solution to produce a rubber latex solution containing the filler, to which the rubber latex particles adhere. Hereinafter, the steps (i-(a)) and (i-(b)) will be described. In the present embodiment, the description is made about an example in which carbon black is used as the filler.

### Step (i-(a))

The step (i-(a)) is a step of dispersing carbon black into a dispersing solvent, and adding, at the time of the dispersing, at least one portion of a rubber latex solution to the dispersing solvent to produce a slurry solution containing the carbon black to which particles of the rubber latex adhere. It is allowable to mix the rubber latex solution beforehand with the dispersing solvent, and subsequently add the carbon black into the resultant mixture to disperse the carbon black therein; or to add the carbon black to the dispersing solvent, and next dispersing the carbon black in the dispersing solvent while adding the rubber latex solution into the mixture at a predetermined adding speed. Alternatively, it is allowable to add the carbon black into the dispersing solvent, and next add a predetermined divided volume of the rubber latex solution several times into the mixture while dispersing the carbon black in the dispersing solvent. By dispersing the carbon black into the dispersing solvent in the presence of the rubber latex solution, the slurry solution containing the carbon black can be produced, in which the rubber latex particles adhere to the carbon black. The addition amount of the rubber latex solution in the step (i-(a)) is, for example, from 0.075 to 12% by mass of the entire amount of the rubber latex solution to be used (the entire amount thereof to be added in the steps (i-(a)) and (i-(b))).

In the step (i-(a)), the solid (rubber) content in the rubber latex solution to be added is preferably from 0.25 to 15%, more preferably from 0.5 to 6% by mass of the carbon black. The concentration of the solid (rubber) in the rubber latex solution to be added is preferably from 0.2 to 5% by mass, more preferably from 0.25 to 1.5% by mass. In these cases, a tire member can be produced in which the dispersion degree of the carbon black is heightened while the rubber latex particles are surely caused to adhere to the carbon black.

In the step (i-(a)), the method for mixing the carbon black with the dispersing solvent in the presence of the rubber latex solution may be a method of dispersing the carbon black, using an ordinary dispersing machine such as a highly shearing mixer, a High Shear Mixer, a homo-mixer, a ball mill, a bead mill, a high-pressure homogenizer, an ultrasonic homogenizer or a colloid mill.

The “highly shearing mixer” means a mixer having a high-speed-rotatable rotor and a fixed stator in which, in the state of making a precise clearance between the rotor and the stator, the rotor is rotated to produce a highly shearing effect. In order to produce such a highly shearing effect, it is preferred to set the clearance between the rotor and the stator to 0.8 mm or less, and set the circumferential speed of the rotor to 5 m/s or more. Such a highly shearing mixer may be a commercially available product. An example thereof is a mixer, “High Shear Mixer”, manufactured by Silverson Machines, Inc.

In the present invention, at the time of mixing the carbon black with the dispersing solvent in the presence of the rubber latex solution, therebyproducing the slurry solution containing the carbon black, to which the rubber latex particles adhere, a surfactant may be added into the solution in order to improve the carbon black in dispersibility. The surfactant may be a surfactant known in the rubber industry. Examples thereof include nonionic surfactants, anionic surfactants, cationic surfactants, and amphoteric surfactants. Instead of the surfactant or in addition of the surfactant, an alcohol such as ethanol may be used. However, when the surfactant is used, it is feared that the finally obtained vulcanized rubber is lowered in rubber physical properties. Thus, the blend amount of the surfactant is preferably 2 parts or less by mass, more preferably 1 part or less by mass for 100 parts by mass of the solid (rubber) content in the rubber latex solution. It is preferred not to use any surfactant substantially.

### Step (i-(b))

The step (i-(b)) is a step of mixing the slurry solution with the rest of the rubber latex solution to produce a rubber latex solution containing the carbon black, to which the rubber latex particles adhere. The method for mixing the slurry solution with the rest of the rubber latex solution in a liquid phase is not particularly limited, andmay be a method of attaining the mixing, using an ordinary dispersing machine such as a highly shearing mixer, a High Shear Mixer, a homo-mixer, a ball mill, a bead mill, a high-pressure homogenizer, an ultrasonic homogenizer or a colloid mill. As required, the whole of the dispersing machine or some other mixing system may be heated at the time of the mixing.

When the dehydrating period and labor are considered in the next step (iii), it is preferred that the rest of the rubber latex solution is higher in solid (rubber) concentration than the rubber latex solution added in the step (i-(a)). Specifically, the solid (rubber) concentration is preferably from 10 to 60% by weight, more preferably from 20 to 30% byweight.

### (2) Step (ii)

The step (ii) is a step of solidifying the rubber latex solution containing the carbon black to produce a rubber solidified product containing the carbon black. The method for the solidifying may be a method of incorporating a solidifier into the rubber latex solution containing the carbon black, to which the rubber latex particles adhere. In this case, the solidifier may be a substance used ordinarily to solidify a rubber latex solution, for example, an acid such as formic acid or sulfuric acid, ora salt such as sodium chloride. It is allowable as the need arises that the present method has, after the step (ii) and before the step (iii), a solid-liquid-separating step such as a centrifugal separation step or a heating step in order to decrease appropriately water contained in the rubber solidified product containing the carbon black.

### (3) Step (iii)

The step (iii) is a step of dehydrating the rubber solidified product containing the carbon black to produce a tire member. In the step (iii), using, for example, a monoaxial extruder, the rubber solidified product containing the carbon black is heated to a temperature of 100 to 250° C., and simultaneously the product is dehydrated while shearing force is applied to the product. According to the present invention, in the step (iii), particularly, a peptizer and the compound (I) are added to the rubber solidified product containing the carbon black to disperse the compound (I) in the water-containing rubber solidified product containing the carbon black while dehydrating the rubber solidified product containing the carbon black. Before the start of the step (iii), the water content by percentage in the rubber solidified product containing the carbon black is not particularly limited. It is preferred to incorporate, e.g., the above-mentioned solid-liquid-separating step into the method of the present invention, as the need arises, and then adjust the water content by percentage to set the Wa/Wb ratio, which will be detailed just below, into an appropriate range.

As described above, by dispersing the compound (I) into the rubber solidified product containing the carbon black in the presence of water, the dispersibility of the compound (I) is remarkably improved. In the case of representing the water amount in the rubber solidified product containing the carbon black at the time of the addition of the compound (I) by Wa, and representing the contained amount of the compound represented by the formula (I) by Wb, it is especially preferred that the following expression is satisfied: 1≤Wa/Wb≤8100. If the Wa/Wb ratio is less than one, the compound (I) may not be sufficiently improved in dispersibilityin the rubber solidified product containing the carbon black. In order to improve the compound (I) further in the dispersibility, the Wa/Wb ratio is preferably one or more. In the meantime, if the Wa/Wb ratio is more than 8100, water to be dehydrated is remarkably large in quantity so that the productivity of tire members tends to be deteriorated. When the productivity of tire members is considered, the Wa/Wb ratio is preferably 7500 or less.

In order to decrease the water content by percentage further in the tire member, a drying step may be separately incorporated, as the need arises after the step (iii), into the method of the present invention. The method for drying the tire member may be a method using a drying machine that may be of various types, such as a monoaxial extruder, an oven, a vacuum drier, or an air drier.

### (4) Step (iv)

In the step (iv), various blending agents are dry-mixed with the tire member as the need arises. The blending agents that can be used may be blending agents used ordinarily in the rubber industry, examples of the agents including a sulfur-containing vulcanizer, a vulcanization promoter, an antiaging agent, silica, a silane coupling agent, zinc oxide, a methylene receptor and a methylene donor, stearic acid, a vulcanization promotion aid, a vulcanization retarder, an organic peroxide, softeners such as wax and oil, and a working aid.

The species of sulfur in the sulfur-containing vulcanizer may be of any ordinary sulfur species for rubbers. Examples thereof include powdery sulfur, precipitated sulfur, insoluble sulfur, and highly dispersible sulfur. The sulfur content in the tire member according to the present invention is preferably from 0.3 to 6.5 parts by mass for 100 parts by mass of the rubber component. If the sulfur content is less than 0.3 part by mass, the vulcanized rubber is short in crosslinkage density to be lowered in rubber strength and others. If the content is more than 6.5 parts by mass, the vulcanized rubber is deteriorated, particularly, in both of heat resistance and durability. In order to keep the rubber strength of the vulcanized rubber good certainly and improve the heat resistance and the durability further, the sulfur content is more preferably set into the range of 1.5 to 5.5 parts by mass for 100 parts by mass of the rubber component.

The vulcanization promoter may be a vulcanization promoter usable ordinarily for vulcanizing rubbers. Examples thereof include sulfenamide type, thiuram type, thiazole type, thiourea type, guanidine type, and dithiocarbamic acid salt type vulcanization promoters. These may be used singly or in the form of an appropriate mixture. The vulcanization promoter content is preferably from 1 to 5 parts by mass for 100 parts by mass of the rubber component.

The antiaging agent may be an antiaging agent usable ordinarily for rubbers, examples thereof including aromatic amine type, amine-ketone type, monophenolic type, bisphenolic type, polyphenolic type, dithiocarbamic acid salt type, and thiourea type antiaging agents. These may be used singly or in the form of an appropriate mixture. The antiaging agent content is preferably from 1 to 5 parts by mass for 100 parts by mass of the rubber component.

A tire member produced by the producing method according to the present invention is restrained from being deteriorated even when stored for a long term. Thus, a vulcanized rubber produced using this tire member as a raw material is restrained from being lowered in physical properties. Thus, the producing method according to the invention is particularly useful as a method for producing a tire member used after the member is stored as the need arises for a long term.

### EXAMPLES

Hereinafter, this invention will be more specifically described by way of working examples of the invention.

### Used Materials

a) Carbon black:

Carbon black “N399”: “SEAST KH” (manufactured by Tokai Carbon Co., Ltd.);
b) Dispersing solvent: Water;
c) Rubber latex solution:

Natural rubber latex solution (NR field latex) (DRC=31.2%) (manufactured by Golden Hope Plantations Berhad);
d) Compound represented by the formula (I):

Sodium
(2Z)-4-[(4-aminophenyl)amino]-4-oxo-2-butenoate (manufactured by Sumitomo Chemical Co., Ltd.;
e) Solidifier: Formic acid (first class 85%, a 10% solution thereof was diluted to be adjusted into a pH of 1.2) (manufactured by Nacalai Tesque, Inc.);
f) Zinc flower: Zinc flower No. 1 (manufactured by Mitsui Mining & Smelting Co., Ltd.);
g) Stearic acid: “LUNACK S-20” (manufactured by Kao Corp.);
h) Wax: “OZOACE 0355” (manufactured by Nippon Seiro Co., Ltd.);
i) Antiaging agents:

(A)
N-phenyl-N′-(1,3-dimethylbutyl)-p-phenylenediamine “6PPD” (manufactured by Monsanto company), and

(B) 2,2,4-Trimethyl-1,2-dihydroquinoline polymer “RD” (manufactured by Ouchi Shinko Chemical Industrial Co., Ltd.);
j) Sulfur: “5% Oil-put finely powdery sulfur” (manufactured by Tsurumi Chemical Industry Co., Ltd.);
k) Vulcanization promoters:

(A) “CBS” (manufactured by Sanshin Chemical Industry Co., Ltd.), and

(B) 1,3-Diphenylguanidine “NOCCELER D” (manufactured by Ouchi Shinko Chemical Industrial Co., Ltd.);
l) Natural rubber: “RSS #3”; and
m) Peptizer: “NOCTIZER SD” (manufactured by Ouchi Shinko Chemical Industrial Co., Ltd.)

### Examples 1 and 2

In each of these examples, the carbon black was added into a natural rubber diluted latex solution in water that had a concentration adjusted into 0.52% by mass, so as to have a blend amount shown in Table 1 (the carbon black concentration in water was 5% by mass). A machine ROBOMIX manufactured by Primix Corp. was used (ROBOMIX conditions: a rotation number of 9000 rpm, and a use period of 30 minutes) to disperse the carbon black into the solution to produce a slurry solution containing the carbon black, shown in Table 1, in which natural rubber latex particles adhered to the carbon black (step (i)-(a)). Next, the above-specified natural rubber latex solution (28%) was added to the slurry solution produced in the step (i-(a)) and including the carbon black, to which the natural rubber latex particles adhered, to have a blend amount shown in Table 2. Next, a mixer for household use, SM-L56 model, manufactured by Sanyo Electric Co. Ltd. was used (mixer conditions: a rotation number of 11300 rpm, and a use period of 30 minutes) to mix the latex solution and the slurry solution with each other to produce a rubber latex solution containing the carbon black, to which the natural rubber latex particles adhered (step (i)).

Formic acid as a solidifier was added to the natural rubber latex solution produced in the step (i) and containing the carbon black, to which the natural rubber latex particles adhered, to change the pH of the whole of the solution to 4. In this way, a natural rubber solidified product containing the carbon black was yielded (step (ii)). The resultant rubber solidified product containing the carbon black was optionally subjected to a solid-liquid separating step to adjust the water amount in the rubber solidified product containing the carbon black to a water amount shown in Table 1. The rubber solidified product containing the carbon black, the peptizer, and the compound represented by the formula (I) were charged into a screw press, V-01 model, manufactured by Suehiro EPM Corp. to disperse this compound (I) in the rubber solidified product containing the carbon black while dehydrating the rubber solidified product containing the carbon black. In this way, a tire member was produced (step (iii)). In the step (iii), the Wa/Wb ratio value is shown in Table 1.

A Bunbury mixer was used to dry-mix various blending agents described in a column in Table 1 with the tire member yielded in each of Examples 1 and 2 (step (iv)). In Table 1, each of the blended amounts is shown as relative parts by mass (phr) when the entire amount of the rubber component was regarded as 100 parts by mass.

### Comparative Examples 1 to 3

In each of the examples, a Bunbury mixer was used to dry-mix the rubber component, the carbon black, and various blending agents shown in a column in Table 1 with each other in the state that these components were completely dry to produce a tire member.

### Comparative Example 4

A tire member was produced in the same way as in Examples 1 to 3 except that in the step (iii), neither any peptizer nor any compound represented by the formula (I) were added to the rubber solidified product containing the filler.

### Comparative Example 5

A tire member was produced in the same way as in Examples 1 to 3 except that in the step (iii), the compound represented by the formula (I) was added to the rubber solidified product containing the filler at a stage when this product was completely dried, and further no peptizer was added thereto.

### Comparative Example 6

A tire member was produced in the same way as in Examples 1 to 3 except that in the step (iii), the peptizer was added to the rubber solidified product containing the filler without adding any compound represented by the formula (I) thereto.

The workability of each of the resultant tire members was evaluated, using the Mooney viscosity thereof as a criterion. Specifically, in accordance with JIS K-6300-1, the Mooney viscosity of the tire member produced in each of the working examples and the comparative examples was measured immediately after the tire member was produced. An evaluation thereof was made, using an index relative to the Mooney viscosity value of the tire member yielded in Comparative Example 1, which was regarded as 100. It is demonstrated that as this value is lower, the tire member is better in workability. The results are shown in Table 1.

The low exothermic property of each of the resultant tire members was evaluated, using the tanδ of a vulcanized rubber obtained therefrom as a criterion. The tire member produced in each of the working examples and the comparative examples was vulcanized at 150° C. for 30 minutes immediately after the production. The tanδ of a sample of the resultant vulcanized rubber was evaluated in accordance with JIS K6265. Specifically, a rheospectrometer, E 4000, manufactured by a company UBM was used to measure the tanδ under conditions of a temperature of 60° C., a frequency of 10 Hz, an initial strain of 15%, and a dynamic strain of ±2.5%. The tanδ of the sample was evaluated, using an index relative to the tanδ value of Comparative Example 1, which was regarded as 100. It is demonstrated that as this value is lower, the vulcanized rubber is better in low exothermic property. The results are shown in Table 1.

In accordance with JIS K6251, the vulcanized rubber of each of the resultant tire members was formed in a sample in the form of a dumbbell No. 3, and the breaking strength thereof was evaluated, using an index relative to the value of Comparative Example 1, which was regarded as 100. It is demonstrated that as this value is higher, the vulcanized rubber is better in breaking strength. The results are shown in Table 1.

TABLE 1

| | | | Com- | Com- | Com- | Com- | Com- | Com- | | |
|---|---|---|---|---|---|---|---|---|---|---|
| | | | parative | parative | parative | parative | parative | parative | Example | Example |
| | | | Example 1 | Example 2 | Example 3 | Example 4 | Example 5 | Example 6 | 1 | 2 |
| Step (iii) | Natural rubber | Parts by mass (phr) | — | — | — | 100 | 100 | 100 | 100 | 100 |
| | (solid content) | | | | | | | | | |
| | Carbon black | Parts by mass (phr) | — | — | — | 50 | 50 | 50 | 50 | 50 |
| | Compound (I) | Parts by mass (phr) | — | — | — | — | 3 | — | 3 | 3 |
| | Peptizer | Parts by mass (phr) | — | — | — | — | — | 0.2 | 0.2 | 0.5 |
| | Water | Parts by mass (phr) | — | — | — | 612 | — | 612 | 612 | 612 |
| | Wa/Wb | — | — | — | — | — | — | — | 204 | 204 |
| Step (iv) | Natural rubber | Parts by mass (phr) | 100 | 100 | 100 | — | — | — | — | — |
| | Peptizer | Parts by mass (phr) | — | — | 0.2 | 0.2 | — | — | — | — |
| | Carbon black | Parts by mass (phr) | 50 | 50 | 50 | — | — | — | — | — |
| | Compound (I) | Parts by mass (phr) | — | 3 | 3 | 3 | — | 3 | — | — |
| | Zinc flower | Parts by mass (phr) | 3 | 3 | 3 | 3 | 3 | 3 | 3 | 3 |
| | Stearic acid | Parts by mass (phr) | 2 | 2 | 2 | 2 | 2 | 2 | 2 | 2 |
| | Wax | Parts by mass (phr) | 2 | 2 | 2 | 2 | 2 | 2 | 2 | 2 |
| | Antiaging | Parts by mass (phr) | 2 | 2 | 2 | 2 | 2 | 2 | 2 | 2 |
| | agent (A) | | | | | | | | | |
| | Antiaging | Parts by mass (phr) | 1 | 1 | 1 | 1 | 1 | 1 | 1 | 1 |
| | agent (B) | | | | | | | | | |
| | Sulfur | Parts by mass (phr) | 2 | 2 | 2 | 2 | 2 | 2 | 2 | 2 |
| | Vulcanization | Parts by mass (phr) | 1.5 | 1.5 | 1.5 | 1.5 | 1.5 | 1.5 | 1.5 | 1.5 |
| | promoter (A) | | | | | | | | | |
| | Vulcanization | Parts by mass (phr) | 0.5 | 0.5 | 0.5 | 0.5 | 0.5 | 0.5 | 0.5 | 0.5 |
| | promoter (B) | | | | | | | | | |

| Tire member workability evaluation | | 100 | 111 | 100 | 103 | 101 | 89 | 96 | 98 |
|---|---|---|---|---|---|---|---|---|---|
| (Mooney viscosity of tire member of | | | | | | | | | |
| Comparative Example 1 = 100) | | | | | | | | | |
| Tire | Tanδ of vulcanized tire member | 100 | 90 | 89 | 81 | 83 | 80 | 79 | 77 |
| member | (Tanδ of vulcanized tire member | | | | | | | | |
| properties | of Comparative Example 1 =100) | | | | | | | | |
| | Breaking strength of vulcanized | 100 | 98 | 92 | 79 | 75 | 78 | 104 | 103 |
| | tire member | | | | | | | | |
| | (Breaking strength of vulcanized | | | | | | | | |
| | tire member of Comparative | | | | | | | | |
| | Example 1 = 100) | | | | | | | | |

What is claimed is:

1. A method for producing a tire member yielded using at least a filler, a dispersing solvent and a rubber latex solution as raw materials, the method comprising:
a step (i) of mixing the filler, the dispersing solvent and the rubber latex solution with each other to produce a rubber latex solution containing the filler,
a step (ii) of solidifying the rubber latex solution containing the filler to produce a rubber solidified product containing the filler; and
a step (iii) of dehydrating the rubber solidified product containing the filler to produce the tire member;
wherein the step (iii) is a step of:
adding, to the rubber solidified product containing the filler, a peptizer and a compound represented by the following formula (I): 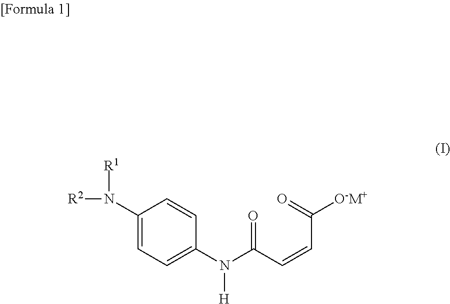
wherein R¹ and R² may be the same as or different from each other, and each represent a hydrogen atom, or an alkyl group, alkenyl group or alkynyl group that has 1 to 20 carbon atoms, and M⁺ represents a sodium ion, potassium ion or lithium ion; and
dispersing the compound represented by the formula (I) in the rubber solidified product containing the filler, this product containing water, while dehydrating the rubber solidified product containing the filler.

2. The method for producing a tire member according to claim 1, wherein in the step (iii), in the case of representing the water amount in the rubber solidified product containing the filler at the time of the addition of the compound represented by the formula (I) by Wa, and representing the contained amount of the compound represented by the formula (I) by Wb, the following expression is satisfied: 1≤Wa/Wb≤8100.

3. A method for producing a tire member yielded using at least a filler and a rubber as raw materials, the method comprising:
adding, to a mixture of the filler and the rubber, a peptizer, water, and a compound represented by the following formula (I) to disperse the compound into the mixture: 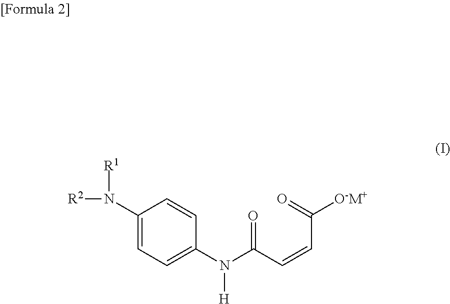
wherein R¹ and R² may be the same as or different from each other, and each represent a hydrogen atom, or an alkyl group, alkenyl group or alkynyl group that has 1 to 20 carbon atoms, and M⁺ represents a sodium ion, potassium ion or lithium ion.

4. The method for producing a tire member according to claim 3, wherein in the case of representing the addition amount of the water by Wa and representing the addition amount of the compound represented by the formula (I) by Wb, the following expression is satisfied: 1≤Wa/Wb≤8100.
